(19) United States
(12) Patent Application Publication
(10) Pub. No.: US 2015/0115768 A1
(43) Pub. Date: Apr. 30, 2015

(54) Radiation Tolerant Nuclear Electric Cell

(71) Applicant: Marvin Tan Xing Haw, Singapore (SG)

(72) Inventor: Marvin Tan Xing Haw, Singapore (SG)

(21) Appl. No.: 14/064,135

(22) Filed: Oct. 26, 2013

(51) Int. Cl. G21H 1/06

(52) U.S. Cl. CPC G21H 1/06
USPC 310/303

(57) ABSTRACT

An electric cell comprises layers of moderating material 1 & 8, nuclear fuel 2 & 7, cathode 3, anode 6, and semiconductor junction layers 4 & 5 adjacently stacked one above another. Ionic compounds with high proton numbers are used to form the semiconductor junction layers 4 & 5. Highly energetic heavy ion daughter nuclides from the nuclear fuel layers 2 & 7 penetrate into the semiconductor junction layers 4 & 5. The collision of heavy ions with the valence band electrons in the semiconductor junction layers 4 & 5 creates electron-hole pairs which provide electricity. If the semiconductor junction layers 4 & 5 are fissile, then the nuclear fuel layers 2 & 7 can be removed.

### TECHNICAL FIELD

The present invention relates to both semiconductor junctions and radioisotopes, and more particularly to a radiation tolerant device which can convert nuclear energy directly into electricity.

### BACKGROUND ART

Nuclear batteries typically comprise radioisotopes and semiconductor junctions. The energetic fission products collide with electrons in the semiconductor lattice, hence exciting electrons from the valence to the conduction band. The excited electrons travel from the conduction band to the cathode, while the holes travel from the valence band to the anode. This allows the direct conversion of the kinetic energy of fission products into electricity.

A patent was filed by Marvin Tan on 20 Dec. 2011 with United Kingdom patent publication number GB2484028. The inventor proposed the use of thermal neutrons to induce the fission of beta-decaying radioisotopes. By increasing the population of beta-particles, more electricity could be generated.

A patent was filed by Ontario Hydro on 29 Jul. 1994 with U.S. Pat. No. 5,606,213. The inventors suggested using amorphous carbon and silicon for the semiconductor junction. Carbon and silicon have low proton numbers.

A patent was filed by Global Technologies Incorporated on 19 Nov. 1994 with U.S. Pat. No. 8,073,097. The inventors suggested that using liquid semiconductors minimizes the effects of radiation damage.

In contrast to the inventions mentioned above, this invention proposes the use of ionic compounds for which the sum of the proton numbers of the cation and anion exceed 60. Ionic compounds with high proton numbers are more radiation tolerant than compounds with low proton numbers.

### STATEMENT OF INVENTION

This invention proposes the use of ionic compounds with high proton numbers as the semiconducting junction to convert the kinetic energy of fission products directly into electricity.

### SUMMARY OF INVENTION

### Technical Problem

Traditional semiconductor homo-junctions made from silicon have very low radiation tolerance. Upon bombardment by the highly energetic heavy ion daughter nuclides, the silicon nuclei are displaced within the silicon lattice. The change in the positions of the silicon nuclei distorts the electronic band-structure of the silicon crystal lattice. The distortion of the electronic band-structure causes the silicon homo-junction to malfunction.

### Solution to Problem

Reducing radiation damage requires minimising the probability of the energetic heavy ions colliding with the nuclei of the semiconductor lattice. This can be done by choosing elements with high proton numbers to form a semiconducting ionic compound. Elements with high proton numbers will form ionic compounds with large ionic radii. This increases the distance between neighbouring nuclei in the semiconductor lattice. This gives the energetic heavy ions more space to travel within the semiconductor lattice without having to collide with the nuclei.

Another benefit of using ionic compounds with high proton number is the increased number of electrons per unit volume in the semiconductor lattice. For example, silicon has a covalent radius of 111 pm. The uranium(IV) cation U⁴⁺ has an ionic radius of 103 pm. The oxygen(II) O²⁻ anion has an ionic radius of 126 pm. Assuming the volume of each atom or ion to be spherical, silicon has an electron density of about 2.44×10³⁰ m⁻³. Uranium dioxide has electron density of approximately 5.06×10³° m⁻³. Uranium dioxide thus has 2.07 times more electrons than silicon, per unit volume. Thus the probability of the energetic heavy ions colliding into electrons is higher in uranium dioxide than in silicon. Thus, an energetic heavy ion is likely to lose its kinetic energy to electrons at a faster rate in uranium dioxide than in silicon. The faster a heavy ion loses its kinetic energy, the less time there is for it to collide with the nuclei in the semiconductor lattice. This results in a lower probability of the heavy ion causing damage to the nuclei.

### Advantageous Effects of Invention

When the criticality of the nuclear fuel is increased, more fission products are generated. The radiation tolerance of the semiconductor junction allows it to receive a higher dosage of radiation to produce more electrical power without malfunctioning.

### BRIEF DESCRIPTION OF DRAWINGS

FIG. 1 An “n-type” material 4 is thermally annealed on top of a “p-type” material 5. The anode metal 6 is deposited below the “p-type” material 5. The cathode metal 3 is deposited above the “n-type” material 4. Nuclear fuel layers 2 & 7 are deposited below the anode 6 and on top of the cathode 3. Moderating material layers 1 & 8 are deposited on top of the top nuclear fuel layer 2, and below the bottom nuclear fuel layer 7.

FIG. 2 The energy band diagram of the anode 6, “p-type” material 5, “n-type” material 4, and cathode 3.

### DESCRIPTION OF EMBODIMENTS

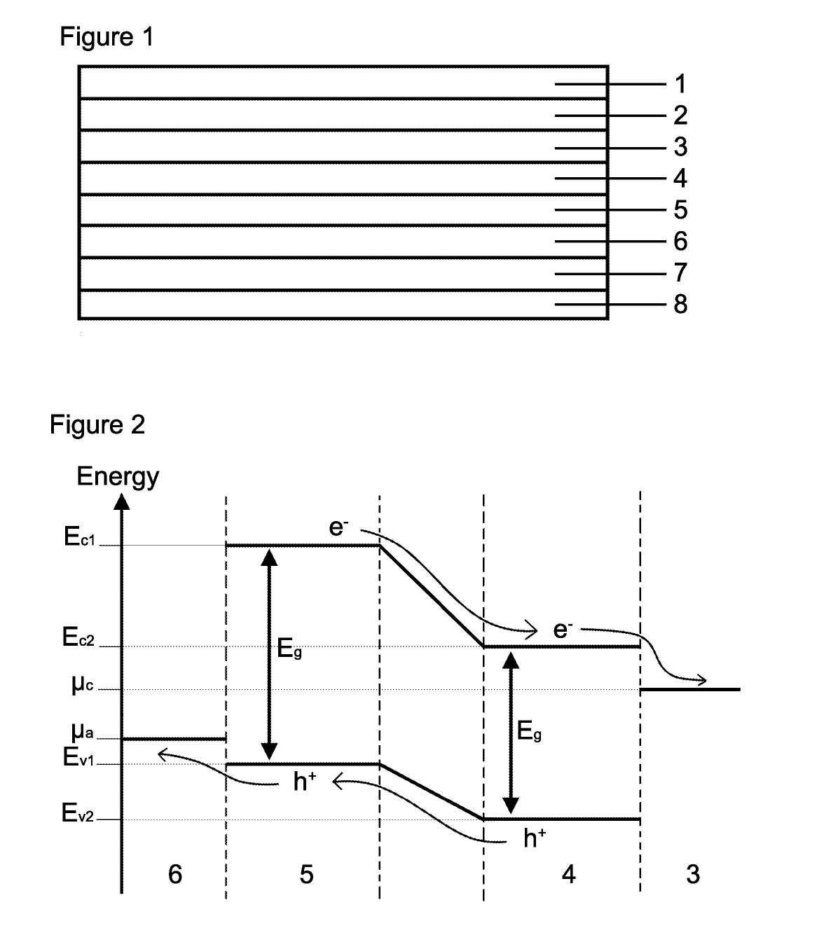

In FIG. 1, the “n-type” 4 and “p-type” 5 materials can be either semiconducting or insulating ionic compounds. If a small band gap is chosen, semiconductors are used. If a large band gap is chosen, insulators are used. The “n-type” 4 and “p-type” 5 materials are chosen to have similar band gaps. The materials need to have high melting temperature to withstand the extreme temperatures of the nuclear fuel layers 2 & 7. The cathode 3 and anode 6 are metals with high melting temperature to withstand the extreme temperatures of the nuclear fuel layers 2 & 7. The moderating materials 1 & 8 enclosing the nuclear fuel layers 2 & 7 serve to convert fast neutrons from the fission reaction, into slow thermal neutrons which sustain the fission chain reaction.

Referring to FIG. 1, if either or both of the “n-type” 4 and “p-type” 5 materials have the additional characteristic of being fissile, then the nuclear fuel layers 2 & 7 can be removed. The fissile “n-type” 4 and “p-type” 5 materials can thus function as both the nuclear fuel and the semiconductor junction.

The choice of chemical compounds as the “n-type” 4 and “p-type” 5 materials in FIG. 1 determines whether the junction will be a hetero junction or a homo-junction. If different ionic compounds are used, a hetero junction results. If the same ionic compound is p-doped on the bottom side with acceptor atoms and n-doped on the top side with a donor atoms, then a homo-junction results.

In FIG. 2, the conduction band edge E_{c1} of the “p-type” material 5 is chosen to be at a higher energy level than the conduction band edge E_{c2} of the “n-type” material 4. Similarly, the valence band edge Eᵥ₁ of the “p-type” material 5 is chosen to be at a higher energy level than the valence band edge Eᵥ₂ of the “n-type” material 4. The chemical potential of the anode μₐ is chosen such that it is at a higher energy level than the valence band edge Eᵥ₁ of the “p-type” material 5. The chemical potential of the cathode μ_{c} is chosen such that it is at a lower energy level than the conduction band edge E_{c2} of the “n-type” material 4.

Referring to FIG. 2, when a heavy ion daughter nuclide collides with a valence band electron, the valence band electron gains enough kinetic energy to surmount the band gap E_{g}. Two possibilities can occur. Firstly, the excited valence electron can behave as an energetic beta-particle by colliding with other valence band electrons and thus exciting them. Secondly, the excited valence band electron can move directly to the conduction band. Both possibilities result in an accumulation of excited electrons e⁻ in the conduction band and accumulation of holes h⁺ in the valence band. The excited electrons e⁻ in the conduction band move along the potential energy gradient towards the cathode 3. The holes h⁺ in the valence band move along the potential energy gradient towards the anode 6. Electricity is thus produced.

### EXAMPLES

Graphite can be used as the moderating material layers 1 & 8 because it has a melting temperature of at least 4000 Kelvins, according to A. I. Savvatimskiy.

Uranium-235 dioxide, plutonium(IV) oxide, and neptunium(IV) oxide are examples of fissile materials which can be used as the top nuclear fuel layer 2 and bottom nuclear fuel layer 7 in FIG. 1.

### Example 1

A single thin film of uranium-238 dioxide can be p-doped with acceptor atoms on the bottom side, and n-doped with donor atoms on the top side. The doped uranium-238 dioxide thin film thus becomes a semiconducting homo-junction which forms the “n-type” 4 and “p-type” 5 materials in FIG. 1.

### Example 2

Thorium(IV) oxide and hafnium(IV) oxide both have similar band gaps of 6 eV (9.6×10⁻¹⁹ Joules). Since they have different valence and conduction band edges, they can be joined to form a hetero junction which forms the “n-type” 4 and “p-type” 5 materials in FIG. 1.

### Example 3

The following compounds have similar band gaps close to 2 eV (3.2×10⁻¹⁹ Joules): tungsten trioxide, gallium(II) selenide, tin(IV) sulfide, zinc telluride. Any two of these four compounds can be used to form the “n-type” 4 and “p-type” 5 materials in FIG. 1.

### Example 4

Uranium-238 dioxide and cadmium telluride both have similar band gaps of 1.4 eV (2.2×10⁻¹⁹ Joules). Since they have different valence and conduction band edges, they can be joined to form a hetero junction which forms the “n-type” 4 and “p-type” 5 materials in FIG. 1.

### Example 5

Uranium-235 dioxide and cadmium telluride both have similar band gaps close to 1.4 eV (2.2×10⁻¹⁹ Joules). Since they have different valence and conduction band edges, they can be joined to form a hetero junction which forms the “n-type” 4 and “p-type” 5 materials in FIG. 1. Because uranium-235 dioxide is a fissile material, it can also function as a fuel layer. Thus, the top nuclear fuel layer 2 and bottom nuclear fuel layer 7 in FIG. 1 can be removed.

### Example 6

Plutonium(IV) oxide and neptunium (IV) oxide both have similar band gaps close to 2.8 eV (4.5×10⁻¹⁹ Joules). Since they have different valence and conduction band edges, they can be joined to form a hetero junction which forms the “n-type” 4 and “p-type” 5 materials in FIG. 1. Because plutonium(IV) oxide and neptunium (IV) oxide are fissile materials, they can also function as fuel layers. Thus, the top nuclear fuel layer 2 and bottom nuclear fuel layer 7 in FIG. 1 can be removed.

### Example 7

A single thin film of plutonium(IV) oxide can be p-doped with acceptor atoms on the bottom side, and n-doped with donor atoms on the top side. The doped plutonium(IV) oxide thin film thus becomes a homo-junction which forms the “n-type” 4 and “p-type” 5 materials in FIG. 1. Because plutonium(IV) oxide is a fissile material, it can also function as a fuel layer. Thus, the top nuclear fuel layer 2 and bottom nuclear fuel layer 7 in FIG. 1 can be removed.

### Example 8

A single thin film neptunium(IV) oxide can be p-doped with acceptor atoms on the bottom side, and n-doped with donor atoms on the top side. The doped neptunium (IV) oxide thin film thus becomes a homo-junction which forms the “n-type” 4 and “p-type” 5 materials in FIG. 1. Because neptunium(IV) oxide is a fissile material, it can also function as a fuel layer. Thus, the top nuclear fuel layer 2 and bottom nuclear fuel layer 7 in FIG. 1 can be removed.

### Example 9

A single thin film of uranium-235 dioxide can be p-doped with acceptor atoms on the bottom side, and n-doped with donor atoms on the top side. The doped uranium-238 dioxide thin film thus becomes a semiconducting homo-junction which forms the “n-type” 4 and “p-type” 5 materials in FIG. 1. Because uranium-235 dioxide is a fissile material, it can also function as a fuel layer. Thus, the top nuclear fuel layer 2 and bottom nuclear fuel layer 7 in FIG. 1 can be removed.

### INDUSTRIAL APPLICABILITY

This invention can be used as a power source for unmanned aerial vehicles, telecommunications satellites, electric cars, ships and submarines. It can also be used to provide electricity in rural areas. All the material layers in FIG. 1 can be fabricated as thin films using epitaxial deposition techniques such as chemical vapour deposition or molecular beam epitaxy.

### REFERENCE SIGNS LIST

1 Moderating Material
2 Top Nuclear Fuel Layer
3 Cathode
4 “n-type” material
5 “p-type” material
6 Anode
7 Bottom Nuclear Fuel Layer
8 Moderating Material
E_{c1} Conduction Band Edge of “p-type” material
E_{c2} Conduction Band Edge of “n-type” material
Eᵥ₁ Valence Band Edge of “p-type” material
Eᵥ₂ Valence Band Edge of “n-type” material
μₐ Chemical potential of Anode
μ_{c} Chemical potential of Cathode
e⁻ Electron
h⁺ Hole
E_{g} Energy Band Gap

### CITATION LIST

### Patent Literature

Inventor: Marvin Tan Xing Haw, “Power-Scalable Betavoltaic Battery”, United Kingdom Patents Journal, Number 6410, Publication date: 28 Mar. 2012, Publication Number GB2484028.
Inventors: Nazir P. Kherani, Walter T. Shmayda, Stefan Zukotynski, Original Assignee Ontario Hydro, “Nuclear batteries”, U.S. Pat. No. 5,606,213, Filing date: Jul. 29, 1994, Issue date: Feb. 25, 1997.
Inventors: Francis Yu-Hei Tsang, Tristan Dieter Juergens, Yale Deon Harker, Kwan Sze Kwok, Nathan Newman, Scott Arden Ploger, Original Assignee: Global Technologies, Inc., U.S. Pat. No. 8,073,097, Filing date: Aug. 29, 2005, Issue date Dec. 6, 2011.

### Non Patent Literature

A. I. Savvatimskiy, Measurements of the melting temperature of graphite and the properties of liquid carbon (a review for 1963-2003), Carbon, Volume 43, Issue 6, May 2005, Pages 1115-1142, ISSN 0008-6223, 10.1016/j.carbon.2004.12.027.

1. An electric cell, comprising:
a layer of moderating material capable of reducing the kinetic energy of neutrons that collide with its constituent atoms, referred to as the top moderator;
a layer containing fissile radioisotopes, referred to as the top nuclear fuel layer, disposed immediately adjacent to the bottom of the said top moderator;
a layer of metal, referred to as the cathode, disposed immediately adjacent to the bottom of the said top nuclear fuel layer;
a layer of uranium-238 dioxide doped with donor atoms, referred to as the “n-type” material, disposed immediately adjacent to the bottom of the said cathode;
a layer of uranium-238 dioxide doped with acceptor atoms, referred to as the “p-type” material, disposed immediately adjacent to the bottom of the said “n-type” material;
a layer of metal, referred to as the anode, disposed immediately adjacent to the bottom of the said “p-type” material;
a layer containing fissile radioisotopes, referred to as the bottom nuclear fuel layer, disposed immediately adjacent to the bottom of the said anode;
a layer of moderating material capable of reducing the kinetic energy of neutrons that collide with its constituent atoms, disposed immediately adjacent to the bottom of the said bottom nuclear fuel layer.

2. The electric cell as recited in claim 1, in which:
the said “n-type” material is replaced with thorium(IV) oxide;
the said “p-type” material is replaced with hafnium(IV) oxide.

3. The electric cell as recited in claim 1, in which the said “n-type” and “p-type” materials are replaced with any of these following compounds which have similar band gaps: tungsten trioxide, gallium(II) selenide, tin(IV) sulfide, zinc telluride.

4. The electric cell as recited in claim 1, in which:
the said “p-type” material is replaced with cadmium telluride.

5. The electric cell as recited in claim 1, in which:
the said “n-type” material is replaced with uranium-235 dioxide;
the said “p-type” material is replaced with cadmium telluride;
the said top nuclear fuel layer is removed;
the said bottom nuclear fuel layer is removed.

6. The electric cell as recited in claim 1, in which:
the said “n-type” material is replaced with neptunium(IV) oxide;
the said “p-type” material is replaced with plutonium(IV) oxide;
the said top nuclear fuel layer is removed;
the said bottom nuclear fuel layer is removed.

7. The electric cell as recited in claim 1, in which:
the said “n-type” material is replaced with plutonium(IV) oxide which has been n-doped with donor atoms;
the said “p-type” material is replaced with plutonium(IV) oxide which has been p-doped with acceptor atoms;
the said top nuclear fuel layer is removed;
the said bottom nuclear fuel layer is removed.

8. The electric cell as recited in claim 1, in which:
the said “n-type” material is replaced with neptunium(IV) oxide which has been n-doped with donor atoms;
the said “p-type” material is replaced with neptunium(IV) oxide which has been p-doped with acceptor atoms;
the said top nuclear fuel layer is removed;
the said bottom nuclear fuel layer is removed.

9. The electric cell as recited in claim 1, in which:
the said “n-type” material is replaced with uranium-235 dioxide which has been n-doped with donor atoms;
the said “p-type” material is replaced with uranium-235 dioxide which has been p-doped with acceptor atoms;
the said top nuclear fuel layer is removed;
the said bottom nuclear fuel layer is removed.
